(19) United States
(12) Patent Application Publication
(10) Pub. No.: US 2018/0219809 A1
(43) Pub. Date: Aug. 2, 2018

(54) SELECTING DEVICE, SELECTING METHOD, AND NON-TRANSITORY COMPUTER READABLE STORAGE MEDIUM

(71) Applicant: YAHOO JAPAN CORPORATION, Tokyo (JP)

(72) Inventor: Tetsuya MATSUZAKI, Tokyo (JP)

(73) Assignee: YAHOO JAPAN CORPORATION, Tokyo (JP)

(21) Appl. No.: 15/868,478

(22) Filed: Jan. 11, 2018

(30) Foreign Application Priority Data
Jan. 31, 2017 (JP) 2017-015614

(51) Int. Cl. H04L 12/58; H04L 29/08

(52) U.S. Cl. CPC H04L 51/04; H04L 51/16; H04L 67/22

(57) ABSTRACT

According to one aspect of an embodiment a selecting device includes an acquiring unit that acquires experience information that indicates experience of a user in a predetermined event. The selecting device includes a selecting unit that selects information to provide to the user based on the experience information.

### CROSS-REFERENCE TO RELATED APPLICATION

The present application claims priority to and incorporates by reference the entire contents of Japanese Patent Application No. 2017-015614 filed in Japan on Jan. 31, 2017.

### BACKGROUND OF THE INVENTION

### 1. Field of the Invention

The present invention relates to a selecting device, a selecting method, and a non-transitory computer readable storage medium.

### 2. Description of the Related Art

With the recent rapid spread of the Internet, information distribution through the Internet has been actively performed. As one example of the information distribution, a technique of proposing a community on the Internet matching with an interest of a user or the like to the user, to facilitate exchanges among users in the community has been known.

Japanese Laid-open Patent Publication No. 2001-249877. However, there is a case in which exchanges among users are not appropriately realized with the above conventional technique.

For example, the above conventional technique proposes, to a user, a community to which multiple users having a common interest belong. However, even with a common interest, when an information disparity exists among users, a hierarchy is created among the users, and as a result, exchanges in the community can become rough by criticism and slander and can cause a phenomenon, such as so-called flaming.

### SUMMARY OF THE INVENTION

It is an object of the present invention to at least partially solve the problems in the conventional technology.

According to one aspect of an embodiment a selecting device includes an acquiring unit that acquires experience information that indicates experience of a user in a predetermined event. The selecting device includes a selecting unit that selects information to provide to the user based on the experience information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 shows one example of selection processing that is performed by an information providing apparatus according to an embodiment;

FIG. 2 is a diagram for explaining one example of processing of selecting information by the information providing apparatus according to the embodiment;

FIG. 3 is a diagram for explaining one example of clusters set by the information providing apparatus according to the embodiment;

FIG. 4 shows a configuration example of the information providing apparatus according to the embodiment;

FIG. 5 shows one example of information that is registered in a user database according to the embodiment;

FIG. 6 shows one example of information that is registered in a cluster database according to the embodiment;

FIG. 7 shows one example of information that is registered in a post information database according to the embodiment;

FIG. 8 is a diagram for explaining one example of processing of updating an allowable gap performed by the information providing apparatus according to the embodiment;

FIG. 9 is a flowchart showing one example of a flow of processing that is performed by the information providing apparatus according to the embodiment; and

FIG. 10 shows one example of a hardware configuration.

### DETAILED DESCRIPTION OF THE PREFERRED EMBODIMENTS

Forms (hereinafter, “embodiments”) to implement a selecting device, a selecting method, and a non-transitory computer readable storage medium according to the present application are explained in detail below referring to the drawings. The embodiments are not intended to limit the selecting device, the selecting method, and the non-transitory computer readable storage medium according to the present application. Like reference symbols are assigned to like parts throughout the following embodiments, and duplicated explanation thereof is omitted.

### Embodiment

### 1. One Example of Information Providing Apparatus

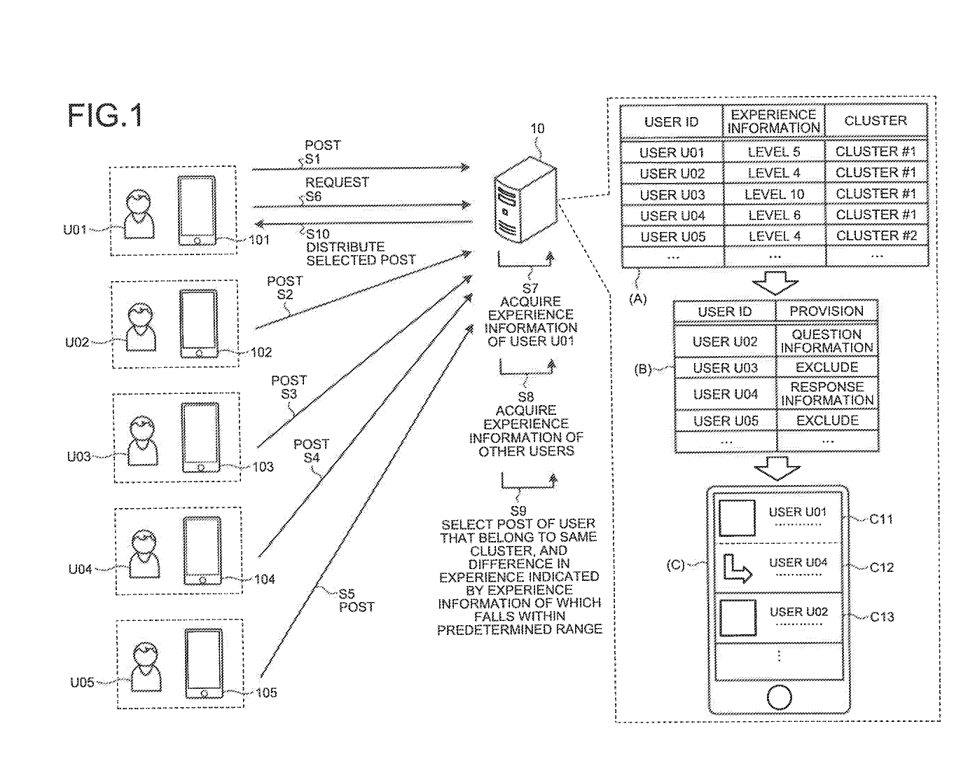

First, one example of selection processing performed by an information providing apparatus that is an example of the selecting device is explained. FIG. 1 shows one example of the selection processing that is performed by the information providing apparatus according to an embodiment.

In the example shown in FIG. 1, one example of information providing processing of selecting, when a distribution request of information posted by users U02 to U05 is received from a user U01, a piece of information to be a subject of distribution by performing selection processing, and of distributing the selected piece of information to the user U01 is described as one example of processing performed by an information providing apparatus 10. Embodiments are not limited to these forms, and the information providing apparatus 10 can distribute information suitable for a user by performing selection processing described later at the time of providing an arbitrary service, such as web search, search for a subject in electronic commerce, exchange of messages between users, and distribution of various kinds of information.

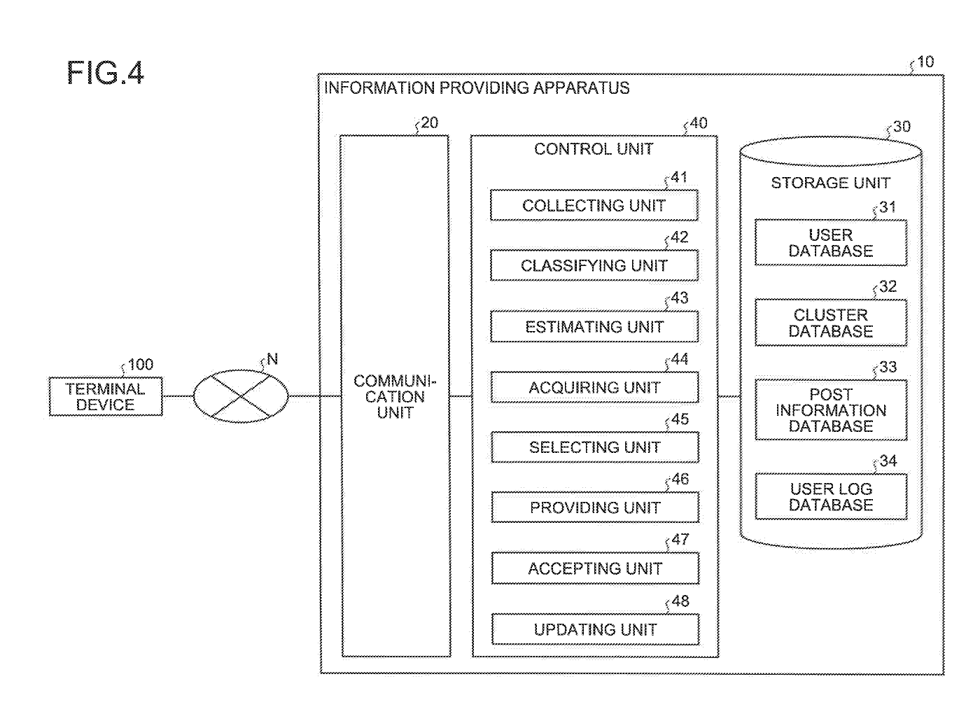

One example of the information providing apparatus 10 shown in FIG. 1 is explained in the following. The information providing apparatus 10 is an information processing apparatus that can communicate with terminal devices 101 to 105 (hereinafter, collectively termed “terminal device 100” in some cases) that are used by the users U01 to U05 (hereinafter, collectively termed “user U” in some cases) through a predetermined network N (for example, see FIG. 4) such as the Internet, and is implemented by, for example, a server device, a cloud system, or the like. The information providing apparatus 10 can be enabled to communicate with the arbitrary number of the terminal devices 100 used by the arbitrary number of users through the network N. Moreover, the information providing apparatus 10 can be enabled to communicate with various kinds of external servers not shown.

The terminal device 100 is a smart device, such as a smartphone and a tablet, used by the user U, and is a portable terminal device that can communicate with an arbitrary server device through a wireless communication network, such as 3rd generation (3G) and long term evolution (LTE). The terminal device 100 is not limited to a smart device, but can be an information processing apparatus, such as a desktop personal computer (PC) and a laptop PC.

### 2-1. One Example of Information Providing Processing

First, one example of a flow of the information providing processing that is performed by the information providing apparatus 10 is explained. For example, the information providing apparatus 10 provides a service that is a so-called social networking service (SNS) to the user U. For example, the information providing apparatus 10 accepts information including various kinds of contents, such as text, still images, moving images, and voice, as post information from the user U. In this case, the information providing apparatus 10 holds the accepted post information.

On the other hand, when a distribution request of post information is received from the user U, the information providing apparatus 10 extracts pieces of information that are posted by the other users U having connection with the user U of the source of request on an SNS. For example, the information providing apparatus 10 extracts pieces of post information that are posted by a user that is registered in advance as a user having a friend relationship with the user U of the source of request, or the other user having the same interest as the user U of the source of request. More specifically, the information providing apparatus 10 extracts pieces of post information that are posted by other users belonging to the same community as the user U based on information about each user registered in advance. Subsequently, the information providing apparatus 10 distributes the extracted post information to the user U of the source of request.

As a result, the information providing apparatus 10 can provide post information that is posted by other users belonging to the same community as the user U of the source of request, such as a user having a friend relationship with the user U of the source of request, and a user having the common interest. Therefore, the information providing apparatus 10 can distribute information in which a user of a source of request is likely to be interested.

The information providing apparatus 10 can distribute information relating to what is termed advertisement together with the post information. The information relating to those advertisements can be information selected according to an attribute of the user U of a source of request, or information selected by selection processing described later in a similar manner as post information. That is, the post information distributed by the information providing apparatus 10 is not limited to information posted by the respective users U, but a concept thereof includes arbitrary information such as advertisement.

### 2-2. Conventional Exchanges

The information providing apparatus 10 enables exchanges between the users U by the information providing processing described above. For example, the information providing apparatus 10 distributes post information relating to various kinds of questions posted by the user U01 to the user U02, and distributes post information that is posted by the user U02 as a response to the post information posted by the user U01 to the user U01, thereby enabling the exchanges between the user U01 and the user U02.

However, there has been a case in which exchanges among users cannot be appropriately done in a conventional technique. For example, in the conventional technique, when a community to which users having a common interest to the user U01 to facilitate exchanges among users, and when the user U01 joined the community, posts of other users belonging to the community are provided to the user U01. However, even with a common interest, if an information disparity exists among the users, a hierarchy is created among the users, and exchanges in the community can become rough by criticism and slander, causing a phenomenon, such as so-called flaming.

For example, suppose that the users U01 to U015 belong to a community of a hobby as “fishing”. In this case, it is assumed that the users U01 to U05 can make conversations about the common hobby, “fishing”. For example, when the user U01 is a beginner with limited experience in fishing and the user U2 is of an intermediate level having some experience in fishing, it is assumed that the user U02 gives a response such as sharing of knowledge with sympathy to a question from the user U01.

However, for example, when the user U01 is a beginner and the user U05 is of an advanced level, the user U05 might post a response including comments criticizing the user U01 in a condescending manner to a question from the user U01. More specifically, as what is asked in the question of the user U01 is quite an obvious fact for the user U05, the user U05 might post a comment, such as “look by yourself”, criticizing the user U01. Furthermore, the user U01 might post a critical comment to the post of the user U05 as above.

Moreover, for example, when the users U01 to U05 are pregnant or people that have experienced childbirth, that is when the users U01 to U05 are people that are raising a child, smooth exchanges can be disrupted due to a difference in experiences or an information disparity. For example, when the user U01 is a user at an early stage of pregnancy, and the user U02 is a user that has experienced childbirth a year ago, there is a high possibility of receiving a response of a sympathetic answer or advice from the user U02 to a comment such as “not feeling well” of the user U01. However, when the user U05 is a user that have experienced childbirth five years ago, the user U05 might have forgotten the feelings at the early stage of pregnancy, and can give a response such as “it will disappear if you rest”.

Furthermore, also in a field other than the examples of a hobby or child-raising described above, for example, when there is a gap in experiences that vary accumulatively, smooth exchanges can be disrupted. For example, when there is a gap in experiences that vary accumulatively by independent action of the users U, such as progress of various kinds of learning activities or games, and business-related ability, smooth exchanges can be disrupted. Moreover, when there is a gap in experiences that vary accumulatively with time, such as entrance into kindergarten or elementary school, and physical changes, smooth exchanges can be disrupted.

### 2-3. Selection Processing

As described, even among the users U that belong to the same community, when there is a gap in experience among the users U, smooth exchanges might not be possible. The information providing apparatus 10 selects information to provide to each user, and provides the selected information thereto. First, the information providing apparatus 10 acquires experience information that indicates experience of the user U relating to a predetermined event. The information providing apparatus 10 then selects information to provide to the user U.

The experience of the user U for a predetermined event is, for example, a condition of a user that varies accumulatively for the predetermined event, or a condition of a user that varies with time. For more specific example, the experience of the user U is a concept including a skill level or progress status in a predetermine event of hobby or ability such as in fishing, cooking, and game. Moreover, the experience of the user U is a concept including a condition of the user U that varies accumulatively with time for a predetermined event, such as in child-raising, entrance into schools, aging, and progress of disease. Furthermore, the experience of the user U is a concept including knowledge that is accumulated in the user U with accumulation of various experience relating to a predetermined event. That is, the information providing apparatus 10 can select information based on experience of the respective users in an arbitrary event when the event is a kind that a gap is caused in experience among users.

When there is a gap in experiences such as a state or knowledge of the user U as described above, even among users that can be categorized in the same cluster for a predetermined event, such as users that are raising a child and users that have a common interest (that is, users belonging to the same community), smooth exchanges can be disrupted by criticism and slander due to a gap in state or knowledge. Furthermore, assuming that a child has a fever, a cause of the fever can differ between an infant and a newborn, and it can be difficult to give an appropriate response.

As described, when there is a gap in experience among users, appropriate exchanges might not be possible. Therefore, the information providing apparatus 10 selects information to provide to each user based on the experience information that indicates experience of each user. More specifically, the information providing apparatus 10 selects information to provide to the user U based on a difference between experience indicated by the experience information of the user U and experience of other users that relate to candidate information of a subject of distribution.

### 2-4. Selection of Information According to Experience

For example, in the case of an SNS, information provided to the user U is post information that is posted by another user. Therefore, the information providing apparatus 10 selects post information to provide to the user U based on a difference between experience indicated by the experience information of the user U and experience indicated by the experience information of the user U that has posted the post information.

For example, when the difference between experiences indicated by the experience information of the user U01 and experiences indicated by the experience information of the user U02 is within a predetermined range, the information providing apparatus 10 provides post information posted by the user U02 to the user U01. When the difference between experiences indicated by the experience information of the user U01 and experiences indicated by the experience information of the user U02 is not within the predetermined range, the information providing apparatus 10 excludes the post information posted by the user U02 from subjects to be provided to the user U01.

For more specific example, when the user U01 is at a beginner level in a predetermined event such as child-raising and hobby and the user U02 is at an intermediate level in the predetermined event, the information providing apparatus 10 provides post information of the user U02 to the user U01. On the other hand, when the user U01 is at a beginner level in a predetermined event such as child-raising and hobby and the user U03 is at an advanced level in the predetermined event, the information providing apparatus 10 exclude post information of the user U03 from subjects to be provided to the user U01.

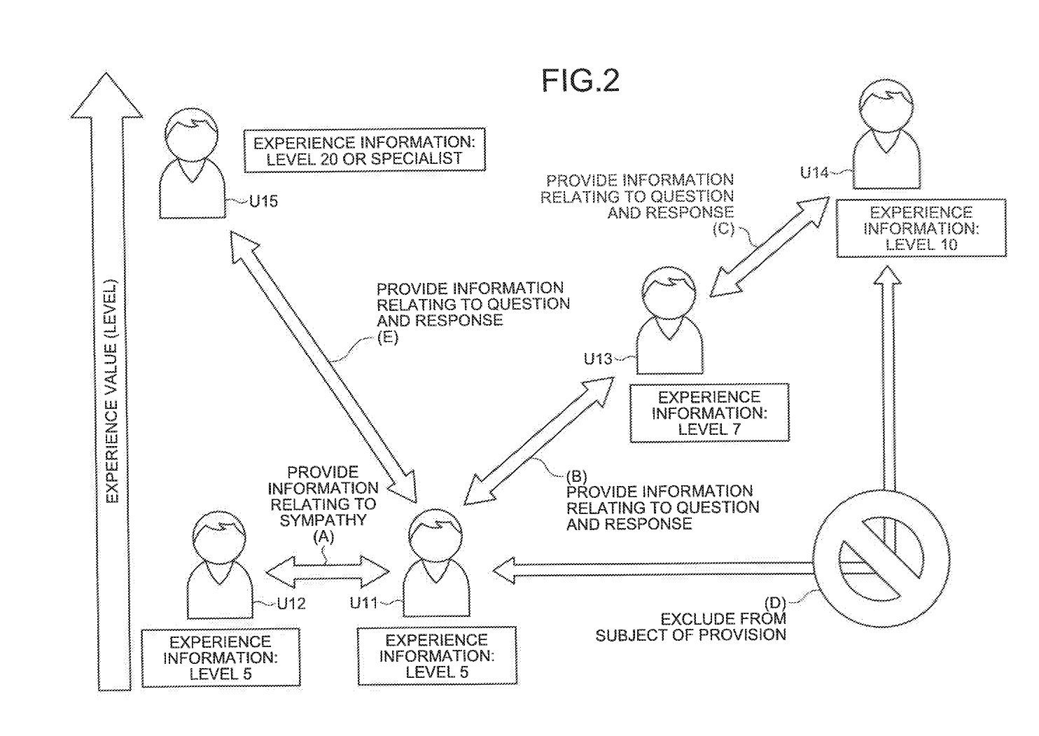

In the following, a specific example of processing of selecting information to be provided to the user U performed by the information providing apparatus 10 is explained using FIG. 2. FIG. 2 is a diagram for explaining one example of the processing of selecting information by the information providing apparatus according to the embodiment. In the example shown in FIG. 2, a specific example of information provided to users U11 to U15 that are currently raising a child (that is, users U11 to U15 that belong to the same community for a common event of “child-raising”) is shown.

The state of the user U relating to child-raising varies according to time spent since the user got pregnant. For example, as an example of a state of the mother, it is thought that morning sickness or cold-like symptoms occur at an early stage of pregnancy, changes of the center of gravity and the like occur at a stable stage of pregnancy, and symptoms such as labor pains occur in the mother at a delivery. Furthermore, it is thought that diagnosis for the mother varies according to time spent since she got pregnant. Moreover, other than the examples described above, it is thought that the state relating to child-raising varies with time, for example, in state of a fetus, an action to be taken by a partner of the user U, an independent action of the user U such as preparation of food and delivery, a problem likely to occur such as morning sickness and back pain, a daily schedule, concerns, recommended supplements and food, and the like. Furthermore, also in a period after delivery, it is thought that a state varies with growth of the child in concerned diseases, required food and drinks, purchase of clothes, entrance into kindergarten and elementally school, and the like.

That is, the physical and mental states of the user U vary gradually and accumulatively as time passes since the user U got pregnant. Moreover, not only the state of the user U herself that is the mother, but also the physical and mental states of other users related to the user U, such as the child and the partner of the user U, can vary with time. The states of the user U herself or other users related to the user U are considered as the state of the user U relating to the event of child-raising, that is, experiences of the user U.

Therefore, the information providing apparatus 10 accepts registration of an expected date of delivery of the user U11, estimates the date of implantation from the accepted expected date of delivery of the user U11, and calculates an experience value of the user U11 based on of days that have passed since the estimated date of implantation. For example, the information providing apparatus 10 assigns a value that expresses experiences relating to child-raising such as “level 5”, and that increases as the experience increases (as time passes since the user got pregnant) to each of the users U11 to U15 as the experience information. The information providing apparatus 10 provides post information of the user U12 to the user U11, for example, when the difference between a level indicated in the experience information of the user U11 and a level indicated in the experience information of the user U12 is within a predetermined range.

For example, in the example shown in FIG. 2, the experience information “level 5” that indicates the stable period of pregnancy is assigned to the users U11 and U12, the experience information “level 7” that indicates that a child is a newborn baby” is assigned to the user U13, and the experience information “level 10” that indicates that a child is a toddler” is assigned to the user U14. Furthermore, in the example shown in FIG. 2, the experience information “level 20” or “specialist” that indicates that the user U15 is a specialist in child-raising, such as a doctor and a nurse, is assigned to the user U15.

When the experience information as above is assigned to each of the users U11 to U15, the information providing apparatus 10 selects information to provide to the user U11 by performing the following processing. For example, the user U11 and the user U12 are the same in level indicated by the experience information. In this case, it is thought that the user U11 and the user U12 can feel sympathy for each other about information relating to child-raising. However, when the levels indicated by the experience information are the same, it might not be possible to give an appropriate response to a question relating to child-raising. Therefore, the information providing apparatus 10 provides post information other than the post information relating to questions and responses as information relating to sympathy between the user U11 and user U12. For example, the information providing apparatus 10 selects post information other than post information relating to questions and responses, such as diary, feelings, and complaints, out of information posted by the user U12, as information to provide to the user U11 as shown in (A) in FIG. 2.

Furthermore, in the example shown in FIG. 2, the experience information of the user U11 is “level 5”, the experience information of the user U13 is “level 7”, and the experience information of the user U14 is “level 10”. In this case, it is thought that the users U13 and U14 can respond to a question relating to child-raising of the user U11 as the users U13 and U14 have experienced the situation being experienced by the user U11.

However, it has been a long time since the user U 14 experienced the situation being experienced by the user U11, and the user U14 might have forgotten the feelings when she experienced the situation or the situation itself. As a result, the user U14 can give a critical response or an irrelevant response to the question of the user U11. Furthermore, when a post relating to a question of the user U11 is provided to the user U14, as the question is too simple for the user U14, the user U14 might give a critical response to the user U11. On the other hand, it is assumed that it has not been a long time since the user U13 experienced a situation that is being experienced by the user U11, and therefore, there is a high possibility that the user U13 responds appropriately to the question of the user U11 with sympathy.

Moreover, when a question of the user U11 is provided to the user U13, as the user U13 have more experience than the user U11, there is a high possibility that the user U13 gives an appropriate response. On the other hand, even if a question of the user U13 is provided to the user U11, as the user U11 has less experience than the user U13, there is a low possibility that the user U11 gives an appropriate response.

Therefore, the information providing apparatus 10 provides a question of a user at a lower level to a user at a higher level when a difference between levels of users is “3” or smaller, and provides a response of a user at a higher level to a user at a lower level. Moreover, when other users have less experience than experience indicated by the experience information of a user, the information providing apparatus 10 selects information relating to a question posted by the other user as information to provide to the user. Furthermore, when another user has more experience than experience indicated by the experience information of a user, the information providing apparatus 10 selects information that is posted by the other user and is relating to a response to a question posted by the user, as information to provide to the user. That is, the information providing apparatus 10 selects information to be provided to the user U based on a difference in experiences of the respective users U and a type of information to be provided.

For example, the information providing apparatus 10 selects a post relating to a question of the user U11 as information to provide to the user U13, and selects information relating to a response of the user U13 as information to provide to the user U11. That is, the information providing apparatus 10 allows provision of information relating to questions and responses between the users U11 and U13, a difference in levels of which is within a predetermined range as shown in (B) in FIG. 2.

Moreover, for example, the information providing apparatus 10 selects a post relating to a question of the user U13 as information to provide to the user U14, and selects information relating to a response of the user U14 as information to provide to the user U13. That is, the information providing apparatus 10 allows provision of information relating to questions and responses between the users U13 and U14, a difference in levels of which is within a predetermined range as shown in (C) in FIG. 2.

The difference between the level of the user U11 and the level of the user U14 is “5”. Therefore, the information providing apparatus 10 avoids providing a post relating to a question of the user U11, and avoids presenting a post relating to a response of the user U14 to the user U11. That is, the information providing apparatus 10 excludes respective information posted by the users U11 and U14 from candidates to be provided to the respective users U11 and U14 when the difference in experiences exceeds a predetermined threshold even if the users U11 and U14 belong to the same cluster as shown in (D) in FIG. 2.

On the other hand, the difference between the level of the user U11 and the level of the user U15 exceeds the predetermined threshold. However, the user U15 is a specialist, and it can be thought that the user U15 can give an appropriate response to the question of the user U11. Therefore, when experience of another user relating to information exceeds a predetermined threshold, the information providing apparatus 10 can include the information related to the other user in subjects to be provided. For example, the information providing apparatus 10 can allow provision of information between the users U11 and U15 irrespective of a difference between the level of the user U11 and the level of the user U15, when the level of the user U15 is “20” or higher, or “specialist”. More specifically, the information providing apparatus 10 can provide a question of the user U11 to the user U15, and can provide a response of the user U15 to the user U11 as shown in (E) in FIG. 2.

### 2-5. Selection of Information According to Cluster

In an SNS or the like, users that belong to the same community, that is, users related to a common event such as hobby and child-raising, exchange information. However, even among users belonging to the same community, when the users have a different sense of values, it is difficult to get sympathy from each other and criticism or slander might occur. Thus, the information providing apparatus 10 classifies users that belong to the same community, that is, the users related to a common event, into clusters according to a sense of values about the event based on an attribute of each user. The information providing apparatus 10 then provides, to a user, information related to another user that is classified into the same cluster as the user, that is a user having the same sense of values as the user for the event.

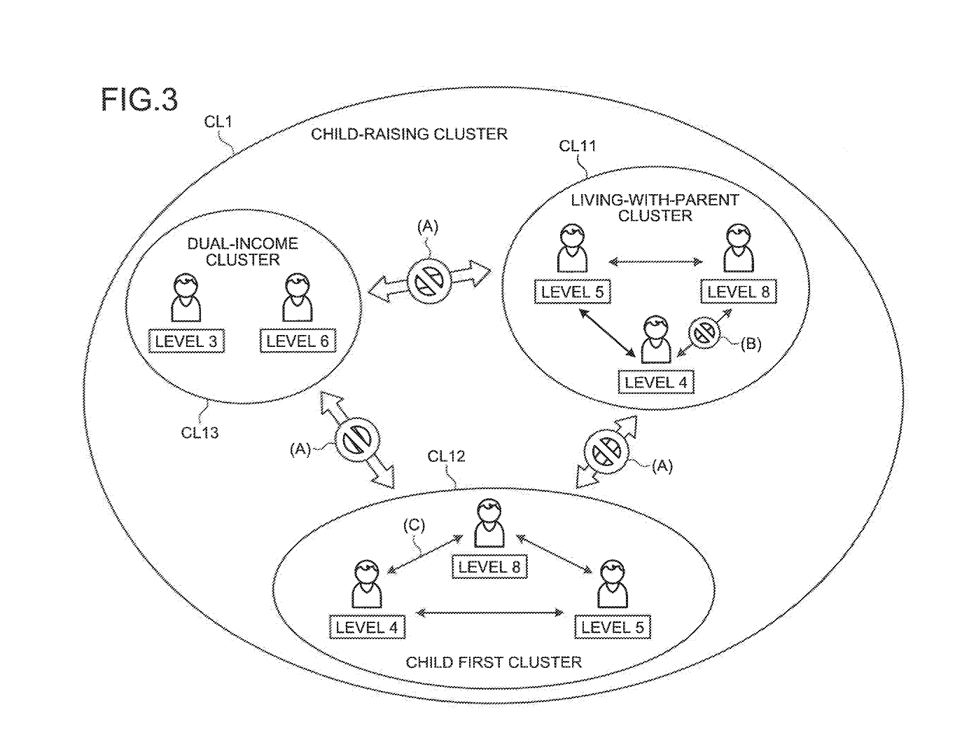

For example, FIG. 3 is a diagram for explaining one example of clusters set by the information providing apparatus according to the embodiment. For example, when the user U that is currently raising a child or when the user U joins a community relating to child-raising, the information providing apparatus 10 classifies the user U into a child-raising cluster CL1. The child-raising cluster CL1 is a cluster corresponding to a so-called community.

Subsequently, the information providing apparatus 10 classifies the user U into either one of clusters CL11 to CL13 according to a sense of values of the user U about child-raising based on respective kinds of attribute information. That is, the information providing apparatus 10 classifies the users related to a predetermined event into either one of clusters according to a sense of values of each of the users U about the event. The information providing apparatus 10 can estimate a sense of values of the user about child-raising based on positional information, browsing history of web contents, purchase history of subjects in electronic commerce, and the like.

For example, it is assumed that the user U that raises a child at her parent's house, the user that gives a high priority to convenience of a child, and the user that raises a child in a family where both parents work have a different sense of values about child-raising. That is, the users U in different child-raising environments are thought to have different senses of values in child-raising. Therefore, the information providing apparatus 10 sets a living-with-parent cluster CL11 that raises a child at her parents' house, a child-first cluster CL12 that gives a high priority to convenience of a child, and a dual-income cluster CL 13 that raises a child while both parents work in advance. The information providing apparatus 10 estimates a situation of the user U based on the respective attribute information of the user U, and classifies the user U into either one of the clusters CL11 to CL13 according to a sense of values about child-raising according to a result of the estimation.

The information providing apparatus 10 limits information to be provided to each user to information posted by a user that is classified into the same cluster. For example, even among the users U that belong to the child-raising cluster CL1, the information providing apparatus 10 can avoid providing information posted by the user U that belongs to the living-with-parent cluster CL11 to users that belong to the other clusters CL12 and CL13, avoid providing information posted by the user U that belongs to the child-first cluster CL12 to users that belong to the other clusters CL11 and CL13, and avoid providing information posted by the user U that belongs to the dual-income cluster CL13 to users that belong to the other clusters CL11 and CL12, as indicated by (A) in FIG. 3.

Moreover, the information providing apparatus 10 can provide information other than post information relating to a question and a response such as complaints and diary across the clusters CL11 to CL13, and can provide post information relating to a question and a response only within each of the clusters CL 11 to CL 13.

An allowable difference in experience within which sympathy is likely to be obtained about an event is thought to vary according to a sense of values about the event. Therefore, when a difference between experience indicated by the experience information of a user and experience of another user related to information is within a predetermined range according to a cluster to which the user is classified, the information providing apparatus 10 can select the information as information to provide to a user. That is, the information providing apparatus 10 can set a threshold of an experience gap per cluster.

For example, in the living-with-parent cluster CL11, the information providing apparatus 10 excludes post information relating to a question and a response from provided information candidates when a difference in level is “4” or larger. For more specific example, among the users U belonging to the living-with-parent cluster CL11, the information providing apparatus 10 avoids providing a question posted by a user at level 4 to a user at level 8, and avoids providing a response posted by a user at level 8 to a user at level 4 as indicated by (B) in FIG. 3.

On the other hand, in the child-first cluster CL12, the living-with-parent cluster CL11 excludes post information relating to a question and a response from provided information candidates when the difference in level is “6” or larger. For more specific example, among the users U belonging to the child-first cluster CL12, the living-with-parent cluster CL11 provides a question posted by a user at level 4 to a user at level 8, and provides a response posted by a user at level 8 to a user at level 4 as indicated by (C) in FIG. 3.

That is, when estimated that users classified into the child-first cluster CL12 respond tolerantly to a difference in experience compared to users classified into the living-with-parent cluster CL11, the information providing apparatus 10 can set a threshold of experience gap to determine whether to provide information in the child-first cluster CL12 to a larger value than a threshold of experience gap to determine whether to provide information in the living-with-parent cluster CL11.

### 2-6. One Example of Selection Processing and Information Providing Processing

Next, one example of flows of the selection processing and the information providing processing performed by the information providing apparatus 10 are explained using FIG. 1. In the example shown in FIG. 1, the users U01 to U05 are users that belong to the same community relating to child-raising. Moreover, in the example shown in FIG. 1, the information providing apparatus 10 classifies the users U01 to U04 into a cluster #1 according to a sense of values about child-raising in advance, and classifies the user U05 into a cluster #2 according to a sense of values about child raising in advance, based on the attribute of the respective users U01 to U05. Furthermore, in the example shown in FIG. 1, post information is provided when a difference in level between users is “4” or smaller.

For example, the information providing apparatus 10 accepts post information including various kinds of contents, such as a question, a response, complaints, and a diary, from the users U01 to U05 (steps S1 to S5). In this case, the information providing apparatus 10 holds the accepted post information. Moreover, the information providing apparatus 10 accepts a request for distribution of post information from the user U01 (step S6). In this case, the information providing apparatus 10 acquires experience information of the user U01 (step S7).

Furthermore, the information providing apparatus 10 acquires experience information of the other users U02 to U05 that belong to the same community as the user U01 (step S8). Subsequently, the information providing apparatus 10 selects post information that is posted by a user, the cluster of which is the same as that of the user U01, and the difference in experience indicated by the experience information of which falls within a predetermined range out of the users U01 to U05 (step S9).

For example, the information providing apparatus 10 identifies the users U02 to U05 that belong to the same community as the user U01 that has issued the request. Subsequently, the information providing apparatus 10 identifies experience information of the users U01 to U05 and clusters to which the users U01 to U05 are classified as shown in (A) in FIG. 1. For example, in the example shown in (A) in FIG. 1, the information providing apparatus 10 identifies the experience information “level 5” and the cluster “cluster #1” of the user U01, the experience information “level 4” and the cluster “cluster #1” of the user U02, the experience information “level 10” and the cluster “cluster #1” of the user U03, the experience information “level 6” and the cluster “cluster #1” of the user U04, and the experience information “level 4” and the cluster “cluster #2” of the user U05.

In this case, the information providing apparatus 10 selects post information that is posted by a user, the difference in experience from the experience of the user U01 of which is within a predetermined range out of the users U02 to U04 belonging to the same cluster “cluster #1” as the user U01. For example, in the example shown in FIG. 1, the difference between the experience information “level 5” of the user U01 and the experience information “level 4” of the user U02 is smaller than a predetermined threshold “4”. Moreover, while there is a low possibility that an appropriate answer is obtained when a question of the user U01 is provided to the user U02 that has less experience than the user U01, there is a high possibility that an appropriate answer is obtained when a question of the user U02 is provided to the user U01. Accordingly, the information providing apparatus 10 selects question information relating to a question as a subject to be provided to the user U01 out of post information that is posted by the user U02 as shown in (b) in FIG. 1.

Furthermore, for example, in the example shown in FIG. 1, the difference between the experience information “level 5” of the user U01 and the experience information “level 10” of the user U03 exceeds the predetermined threshold “4”. In this case, there is a low possibility that the user U03 gives an appropriate response to a question of the user U01. Accordingly, the there is a low possibility information providing apparatus 10 excludes post information that is posted by the user U03 from subjects to be provided to the user U01 as shown in (B) in FIG. 1.

For example, in the example shown in FIG. 1, the difference between the experience information “5” of the user U01 and the experience information “level 6” of the user U04 is smaller than the predetermined threshold “4”. Moreover, there is a high possibility that an appropriate answer is obtained when a question of the user U01 is provided to the user U04 that has more experience than the user U01. Accordingly, the information providing apparatus 10 selects response information relating to a response to the question information posted by the user U01 as a subject information to be provided to the user U01 out of pieces of post information that are posted by the user U04 as shown in (B) in FIG. 1.

Thus, the information providing apparatus 10 creates a content in which question information C01 posted by the user U01 before, response information C12 of the user U04 to the question information C11, question information C13 posted by the user U02, and the like are aligned, and distributes the created content to the terminal device 101 of the user U01 as shown in (C) in FIG. 1. That is, the information providing apparatus 10 distributes information that is selected based on a difference in experience of the users U01 to U05 or a cluster according to a sense of values to the user U01 (step S10). As a result, the information providing apparatus 10 can provide a sympathetic response or an appropriate response to a question of the user U01, a question to which the user U01 can respond with sympathy, and the like. Therefore, harmonious exchanges among users are enabled, and a phenomenon such as flaming can be prevented in advance.

### 2-7. Experience

In the above example, the information providing apparatus 10 selects information to provide to the user U according to an experience gap in child-raising. The information providing apparatus 10 can select information to provide to the user U according to a gap in experience that varies accumulatively by positive actions of the user U such as learning, besides experience that varies accumulatively with time such as child-raising. That is, the information to provide to information providing apparatus 10 can select information based on a difference in state of the user U relating to an arbitrary event, as long as information to be provided to the user U01 is selected based on a difference in state of the user U that varies accumulatively. More specifically, the information providing apparatus 10 can select information to provide to the user U based on an experience gap in an arbitrary event.

### 2-8. Information Providing Form

In the above example, the information providing apparatus 10 provides, for example, a question of the user U11 to the user U13 having more experience than the user U01, and provides a response of the user U13 to the user U11. However, embodiments are not limited thereto. For example, the information providing apparatus 10 can provide post information other than a question and a response, such as complaints and a diary, to the user U13.

Moreover, the information providing apparatus 10 can avoid providing post information relating to a question and a response of the user U11 to the user U14 having an experience gap larger than the predetermined threshold, but can provide post information other than the post information relating to a question and a response of the user U11. On the other hand, as post information other than a post relating to a question and a response posted by the user U14 is likely to evoke sympathy of the user U11 even if provided to the user U11, the information providing apparatus 10 can avoid providing all kinds of post information posted by the user U14 to the user U11. That is, the information providing apparatus 10 can set an inclination to information to be provide to each other among users having experience gaps.

Furthermore, the information providing apparatus 10 can provide only a response to a question that is posted by the user U11 out of responses posted by the user U13, and can provide a response that corresponds to a question posted by a user other than the user U11. For example, the information providing apparatus 10 can present questions that are posted by the users U11 and U12 to the user U13, and can provide responses of the U13 to each of the questions to both of the users U11 and U12. Furthermore, for example, when providing a response of the user U13 to a question of the user U12 to the user U11, the information providing apparatus 10 can provide the response of the user U13 along with the question of the user U12.

### 2-9. Experience Information

In the above example, an example in which the experience information of the user U is registered in the information providing apparatus 10 is described. The information providing apparatus 10 can estimate experience of the user U in an event relating to a community to which the user U belongs, and can generate the experience information that indicates the estimated experience. For example, the information providing apparatus 10 identifies an event relating to the community to which the user U belongs, and estimates experience of the user U in the identified event.

For more specific example, when the user U belongs to a community relating to “child-raising”, the information providing apparatus 10 can estimate experience in “child-raising”of the user U based on information registered by the user U in advance, positional information of the user U, history of actions of the user U, such as history of search queries input by the user U, history of web contents browsed by the user U, history of purchases of the user U, text contents posted by the user U in a microblog or the like, and contents of messages transmitted by the user U, and can generate experience information that indicates the estimated experience (for example, experience information that indicates an experience value such as levels).

Moreover, the information providing apparatus 10 can generate experience information of the user U per community to which the user U belongs, and can select information to provide to the user U per community. For example, when the user U belongs to a community relating to “fishing” and a community relating to “child-raising”. In this case, the information providing apparatus 10 acquires experience information about “fishing” and experience information about “child-raising” as the experience information of the user U. Furthermore, the information providing apparatus 10 selects information to provide to the user U by the selection processing described above from information posted by users that belong to the community relating to “fishing”, and information posted by users that belong to the community relating to “child-raising” by the selection processing described above. Subsequently, the information providing apparatus 10 can provide the respective selected information to the user U.

### 2-10. Provision to Related Users

Moreover, for example the information providing apparatus 10 can select information to provide to another user related to the user U, such as a partner of the user U, based on the experience information of the user U. For example, when accepting a request for information from the user U07 that is the partner of the user U01, the information providing apparatus 10 identifies the user U01 that is registered as the partner of the user U07 in advance, and selects information to provide to the user U07 based on the experience information of the identified user U01.

As a result of this processing, for example, the information providing apparatus 10 can provide, to a husband having a wife that is raising a child, information that is selected according to experience (that is, a state that varies accumulatively) of the wife that is raising a child. For more specific example, the information providing apparatus 10 can provide information to encourage support according to a state of pregnancy or a state of child-raising to a husband having a wife that is currently raising a child.

### 2-11. Adjustment of Gap

The extent of a gap in experience that allows provision of information can be determined arbitrarily. For example, if flaming or argument occur when question and responses are provided among users, the difference in level of which is “3” or smaller in one cluster, the information providing apparatus 10 can provide a question or a response among users, the difference in level of which is “2” or smaller in the cluster. Moreover, if an average value of the number of responses to each question falls short of a predetermined threshold when questions and responses are provided among users, the difference in level of which is “3” or smaller in one cluster, the information providing apparatus 10 can provide questions and responses among users, the difference in level of which is “4” or smaller in the cluster. That is, the information providing apparatus 10 can change the experience gaps among users allowing provision of information (hereinafter, “allowable gap”) based on contents of a response corresponding to a question, the number of responses, or the like.

Furthermore, the information providing apparatus 10 can change the allowable gap based on an evaluation of a response. For example, the information providing apparatus 10 provides buttons to accept a favorable evaluation such as “like!”, a negative evaluation such as “dislike”, and the like along therewith when distributing a response to one question, and accepts an evaluation of the response. The information providing apparatus 10 can adjust the allowable gap such that the number of favorable evaluations to a response becomes large. Moreover, the information providing apparatus 10 can adjust the allowable gap such that the number of negative evaluations to a response becomes small. The information providing apparatus 10 can select information as information to provide to the user U when the difference in experience that is indicated by the experience information of the user U and experience of another user related to information falls within a range of the allowable gap based on accepted evaluations.

### 2-12. Application to Another Embodiment

In the above example, the information providing apparatus 10 provides, to the user U, post information that is posted by another one of the user U. However, embodiments are not limited thereto. That is, the information providing apparatus 10 can select arbitrary information as long as information to be provided to the user U is selected according to experience of the user U, which is a destination of provided information.

For example, the information providing apparatus 10 can perform selection of information to be provided to a user not in an SNS but in a so-called bulletin board service. Moreover, the information providing apparatus 10 can perform selection of a message to be provided to each user based on experience of each user when messages are exchanged among users that belong to the same community.

Furthermore, the information providing apparatus 10 can select information to provide to the user U from among pieces of information corresponding to search queries that are input by the user U based on the experience information of the user U. That is, the information providing apparatus 10 can perform the selection processing described above at the time of web searching, various content searching, and searching for an object of transaction, and can perform listing according to a result of the selection processing. Moreover, when performing this processing, the information providing apparatus 10 can identify a user related to information to be a provided information candidate, and can select the information as a subject to be provided when the difference between experience of the identified user and experience of a user to be a destination of distribution of the information falls within the allowance gap.

For example, the information providing apparatus 10 identifies web contents corresponding to a search query that is input by the user U in web searching. Moreover, the information providing apparatus 10 identifies a user related to each of the identified web contents. For example, the information providing apparatus 10 identifies a user that has browsed each of the identified web contents. Subsequently, the information providing apparatus 10 acquires experience information of the identified user, and performs listing of web contents based on experience indicated by the acquired experience information and experience indicated by the experience information of the user U that has performed web searching.

For example, when the experience information of the user U that has performed web searching is related to “child-raising”, the information providing apparatus 10 extracts experience information relating to “child-raising” out of experience information of users that have browsed a web content for each of web contents that correspond to a search query input by the user U. Subsequently, the information providing apparatus 10 calculates an average value of experience that is indicated by the extracted experience information. The information providing apparatus 10 then provides a web content for which the difference between the calculated average value of experience and the experience indicated by the experience information of the user U falls within a range of the allowable gap, giving a higher priority thereto, to the user U.

The information providing apparatus 10 can perform the processing described above per event relating to the experience information, and can perform scoring according to whether to fall within a range of the allowable gap, to present a web content scoring high with a higher priority. For example, the information providing apparatus 10 can present a web content that is often browsed by a user having similar experience to the user U, or a web content for which the allowable gap falls within a predetermined range, and that is often browsed by a user having more experience than the user U with higher priority.

Furthermore, when providing information about an object of transaction corresponding to a search query, the information providing apparatus 10 identifies a user that has browsed information about the object of transaction corresponding to the search query, and a user that has purchased the object of transaction. The information providing apparatus 10 can present the information about the corresponding object of transaction, giving a higher priority thereto when the difference between experience of the user U that has input the search query and experience of the identified user fall within an allowable range.

Moreover, when distributing advertisements to the user U, the information providing apparatus 10 can perform distribution of an advertisement that is selected by the selection processing described above. For example, the information providing apparatus 10 acquires experience information of a user that has done a predetermined acquisition action, such as a user that has chosen an advertisement, and a user that has purchased an object of transaction related to the advertisement, for each of advertisements. At the time of distributing an advertisement to the user U, the information providing apparatus 10 can compare the experience information of the user U and the experience information acquired for each of the advertisements, and can select an advertisement, the allowable gap of which falls within a predetermined range as a subject of distribution. Furthermore, the information providing apparatus 10 can select an advertisement that is selected more times than a predetermined threshold by users that have more experience than the user U as a subject of distribution. Moreover, the information providing apparatus 10 can exclude an advertisement that is selected more times than a predetermined threshold by users that have less experience than the user U from subjects of distribution.

Furthermore, for example, the information providing apparatus 10 can select a web content, an advertisement, information about an object of transaction, or the like that is highly related to a user that belongs to the same cluster as the user U, and the difference in experience from the user U of which is within an allowable range. Moreover, for example, the information providing apparatus 10 can exclude a web content, an advertisement, information about an object of transaction, or the like that is highly related to a user that belongs to the same cluster as the user U, and the difference in experience from the user U of which exceeds an allowable range from subjects of selection. Furthermore, for example, the information providing apparatus 10 can exclude a web content, an advertisement, information about an object of transaction, or the like that is highly related to a user that belongs to a cluster different from that of the user U.

Moreover, the information providing apparatus 10 can change the allowable range for each of a case of distributing a web content, a case of distributing an advertisement, and a case of distributing information about an object of transaction. Furthermore, the information providing apparatus 10 can calculate a score according to a result of comparison between experience of the user U and experience of a user related to candidate information of a subject to be provided, and can perform selection of information to be a subject to be provided based on the calculated score.

That is, when providing various kinds of information to the user U, the information providing apparatus 10 identifies a user that is related to the information, and compares experience of the identified user and experience of the user U to be a destination to be provided. The information providing apparatus 10 can distribute not only a post but arbitrary information, such as an advertisement and a web content, in an arbitrary form as long as the information providing apparatus 10 selects information to be a subject of distribution according to whether experience of the identified user and experience of the user U fall within an allowable range, a difference between the experience of the identified user and the experience of the user U, a type of information to be a subject of distribution, and the like.

### 2-13. Selection of Information

In the above explanation, the information providing apparatus 10 selects information to be a subject of distribution based on a difference in experience between the user U to be a destination of distribution of various kinds of information, such as post information and web contents, and another user that is related to information that can be provided to the user U (hereinafter, “provided information candidate”), such as a user that has posted the post information. Embodiments are not limited thereto. For example, the information providing apparatus 10 can set priorities for providing information to be a provision candidate to the user U based on a difference between experience indicated by the experience information of the user U and experience of another user that is related to the information to be a provision candidate. For example, the information providing apparatus 10 can give a higher priority to post information that is estimated that the user U is likely to sympathize therewith.

For more specific example, the information providing apparatus 10 assigns priority “1” to post information that relates to a response to a question of the user U out of pieces of post information that are posted by other users, the difference in experience from the user U is within the allowable gap, and that have more experience than the user U. Moreover, for example, the information providing apparatus 10 assigns priority “2” to post information that relates to a question out of pieces of post information that are posted by other users having less experience than the user U. Furthermore, the information providing apparatus 10 assigns priority “3” to post information other than a question and a response out of pieces of post information that are posted by other users, the difference in experience from the user U of which is the same.

Moreover, for example, the information providing apparatus 10 assigns priority “4” to post information that is posted by another user, the difference in experience from the user U of which is out of a predetermined allowable gap. The information providing apparatus 10 distributes respective post information that is posted by other users that belong to the same cluster as the user U so as to be displayed in a display mode according to the priorities assigned to the respective post information. More specifically, the information providing apparatus 10 distributes the respective post information such that post information assigned with a higher priority (for example, a priority value closer to “1”) is displayed in a display mode enabling the user U to browse more easily. As a result, the information providing apparatus 10 can provide, to the user U, post information that is likely to obtain sympathy of the user U, giving priority thereto.

For example, the information providing apparatus 10 can select only post information having a priority value higher than a predetermined threshold as a subject of distribution. Moreover, the information providing apparatus 10 can generate a content in which multiple pieces of post information are aligned in descending order of priority value to distribute the generated content, or can distribute pieces of post information sequentially in descending order of priority value and instruct the terminal device 100 to display the pieces of post information aligned in the distributed order. Furthermore, when the priority is lower than a predetermined threshold (for example when the priority value is “4” or larger), the information providing apparatus 10 can perform various kinds of filtering disabling viewing by a normal browsing operation when the user U sets various kinds of filtering, of when the predetermined number or more pieces of post information are aligned to be displayed (that is, when post information at levels lower than a predetermine threshold is also displayed).

As described, the information providing apparatus 10 can set priorities according to a combination of a difference between experience of the user U to be a destination of distribution and experience of another user related to information to be a provision candidate, and a type of the information to be a candidate to be provided, and can provide information to the user U according to the set priorities. That is, the information providing apparatus 10 can set priorities for providing information to the user U in in a viewpoint similar to that in selecting information to be a subject of provision in the above explanation, and can perform distribution according to the set priorities.

### 2-14. Others

The information providing apparatus 10 can adopt the conditions described above in an arbitrary combination. Furthermore, the information providing apparatus 10 can adopt only a part of the processing described above.

### 3. Configuration of Information Providing Apparatus

One example of a functional configuration of the information providing apparatus 10 described above is explained below. FIG. 4 shows a configuration example of the information providing apparatus according to the embodiment. As shown in FIG. 4, the information providing apparatus 10 includes a communication unit 20, a storage unit 30, and a control unit 40.

The communication unit 20 is implemented by, for example, a network interface card (NIC), or the like. The communication unit 20 is connected to a network N in a wired or wireless manner, and communicates information with the terminal device 100.

The storage unit 30 is implemented, for example, by a semiconductor memory device, such as a random-access memory (RAM) and a flash memory, or by a storage device of a hard disk, an optical disk, or the like. Moreover, the storage unit 30 stores a user database 31, a cluster database 32, a post information database 33, and a user log database 34.

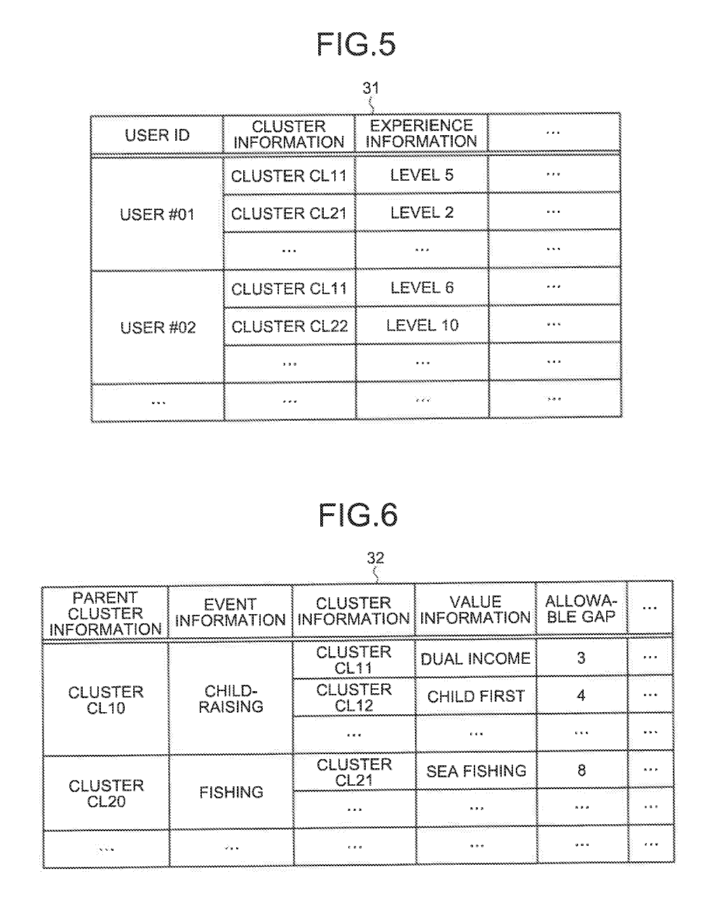

In the following, one example of information registered in each of the databases 31 to 34 is explained. In the user database 31, information about the user U is registered. For example, FIG. 5 shows one example of information that is registered in the user database according to the embodiment. In the example shown in FIG. 5, in the user database 31, information such as “user identifier (ID)”, “cluster information”, and “experience information” is registered. The user database 31 can register any information relating to the user U besides the information shown in FIG. 5. In the example shown in FIG. 5, conceptual values such as “user 101” and the like are used, but in the actual user database 31, numeric values and character strings to identify a user are registered.

The “user ID” is an identifier to identify the user U. The “cluster information” is information that indicates a cluster to which the user U identified by the associated “user ID” is classified, and is information that is set per community to which the user U belongs. Furthermore, the “experience information” is information that indicates experience of the user U identified by the associated “user ID” in an event corresponding to a cluster that is indicated by the associated “cluster information” (that is, an event corresponding to a community that corresponds to the cluster).

For example, in the example shown in FIG. 5, the user ID “user 101”, the cluster information “cluster CL11”, and the experience information “level 5” are associated with each other and registered in the user database 31. The information as above indicates that a user that is indicated by the user ID “user #01” is classified into a cluster that is indicated by the cluster information “cluster CL11”, and experience of the user that is indicated by the user ID “user #01” in an event corresponding to the cluster indicated by the cluster information “cluster CL11” is indicated by the experience information “level 5”.

In the cluster database 32, various kinds of information relating to clusters are registered. For example, FIG. 6 shows one example of information that is registered in a cluster database according to the embodiment. In the example shown in FIG. 6, information such as “parent cluster information”, “event information”, “cluster information”, “value information”, and “allowable gap” is registered in the cluster database 32. The cluster database 32 can register any information relating to clusters.

The “parent cluster information” is information that indicates a cluster to which various clusters belong, that is, a parent cluster constituting a community. The “event information” is information that indicates an event corresponding to an associated parent cluster, that is, information that indicates an event such as a hobby and a state common among users that belong to the parent cluster. Furthermore, the “cluster information” shown in FIG. 6 is information that indicates a cluster belonging to an associated parent cluster. The “value information” is information that indicates a sense of values of a user classified into a cluster indicated by the associated “cluster information” of an event that is indicated by the associated “event information”. The “allowable gap” is information that indicates an allowable gap in a cluster indicated by the associated “cluster information”.

For example, in the example shown in FIG. 6, the parent cluster information “cluster CL10”, the event information “child-raising”, the cluster information “cluster CL11”, the value information “dual income”, and the allowable gap “3” are associated and registered in the cluster database 32. The information as above indicates that a parent cluster that is indicated by the parent cluster information “cluster CL10” is a community to which a cluster corresponding to an event that is indicated by the event information “child-raising”, that is, a user raising a child, belongs. Moreover, the information as above indicates that a cluster that is indicated by the cluster information “cluster CL11” is included in the parent cluster that is indicated by the parent cluster information “cluster CL10”. Furthermore, the information as above indicates that to the cluster that is indicated by the cluster information “cluster CL11”, the user U having a sense of values that is indicated by the value information “dual income” about the event that is indicated by the event information “child-raising” is classified. Moreover, the information as above indicates that the allowance gap in the cluster that is indicated by the cluster information “cluster CL11” is “3”.

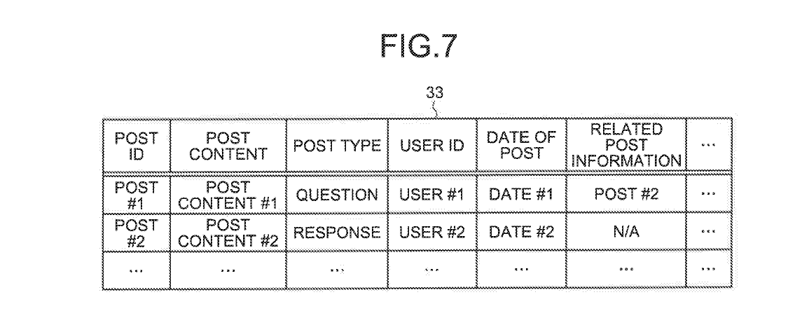

In the post information database 33, various kinds of post information that are posted by the user U are registered. For example, FIG. 7 shows one example of information that is registered in the post information database according to the embodiment. In the example shown in FIG. 7, information such as “post ID”, “post content”, “post type”, “user ID”, “date of post”, and “related post information” is registered. In the post information database 33, any information relating to a post of the user U can be registered besides the information shown in FIG. 7.

The “post ID” is an identifier to identify each post information. Moreover, the “post content” is contents of text, image, and the like posted by the user U, that is, post information. Moreover, the “post type” is information that indicates a type of post information, and is information that indicates, for example, whether the post information is information relating to a question, information relating to a response, or information other than a question or a response. Furthermore, the “user ID” is a user ID of a user that has posted associated post information.

The “date of post” is information that indicates a date and a time when associated post information is posted. Moreover, the “related post information” is a post ID of post information that is related to associated post information. More specifically, the “related post information” is a post ID of a response to associated post information. In the example shown in FIG. 7, a conceptual value such as “post #2”, “post content #1”, and “date #1” is described, but in the actual post information database 33, numeric values or character strings to identify post information, various kinds of contents to be the post information, a numeric value indicating the date of post, and the like are registered.

For example, in the example shown in FIG. 7, the post ID “post #1”, the post content “post content #1”, the post type “question”, the user ID “user #1”, the date of post “date #1”, and the related post information “post #2” are associated and registered in the post information database 33. The information as above indicates that a content of post information that is indicated by the post ID “post #1” is “post content #1”, and the type is “question”. Moreover, the information as above indicates that the post indicated by the post ID “post #1” is posted by a user that is indicated by the user ID “user #1” at a time and date indicated by the date of post “date #1”. Furthermore, the information as above indicates that to the post that is indicated by the post ID “post #1”, post information that is indicated by “post #2” is posted as a response.

In the user log database 34, various kinds of activity histories of the user U are registered. For example, various kinds of activity histories such as a position history of the user U, a browsing history of web contents of the user U, a search history of the user U, a purchase history of objects of transaction by the user U of the user U are registered. In the user log database 34, various kinds of activity histories similar to conventional ones are registered in the user log database 34, and detailed illustration of information registered in the user log database 34 is omitted.

Explanation is continued, referring back to FIG. 4. The control unit 40 is a controller, and is implemented, for example, by executing various kinds of programs that are stored in a storage device in the information providing apparatus 10 by a processor, such as a central processing unit (CPU) and a micro processing unit (MPU), using the RAM or the like as a work area. Moreover, the control unit 40 is a controller, and can be implemented also by, for example, an integrated circuit such as an application specific integrated circuit (ASIC) and a field programmable gate array (FPGA).

As shown in FIG. 4, the control unit 40 includes a collecting unit 41, a classifying unit 42, an estimating unit 43, an acquiring unit 44, a selecting unit 45, a providing unit 46, an accepting unit 47, and an updating unit 48. The collecting unit 41 collects an activity history of the user U. For example, the collecting unit 41 collects an activity history of the user U from various kinds of external servers, such as an external server providing services relating to web search, and an external server providing services relating to electronic commerce, and registers the collected activity history in the user log database 34 as a user log.

The classifying unit 42 classifies the user U to either one of clusters according to a sense of values of the user U about a predetermined event based on an attribute of the user U. For example, when accepting an entry indicating that the user U belongs to one of communities from the user U, the classifying unit 42 identifies an event that corresponds to the community to be registered. For example, the classifying unit 42 identifies event information that is associated with the parent cluster information that indicates the community selected by the user U from the cluster database 32.

Subsequently, the classifying unit 42 estimates a sense of values of the user about an event that is indicated by the identified event information based on the activity history of the user U, and identifies a cluster that corresponds to the estimated sense of values. For example, the classifying unit 42 estimates whether the user U has a sense of values of a user belonging to the “dual income” cluster, a sense of values of a user belonging to the “child first” cluster, or a sense of values of a user belonging to the “living-with-parent” cluster, based on a history of search queries, buying patterns, or the like. The classifying unit 42 then registers the cluster information that indicates a cluster according to the estimated sense of values in the user database 31, associating with the user ID of the user U.

The estimating unit 43 estimates experience of the user U in a predetermined event based on an activity history of the user U. More specifically, the estimating unit 43 estimates a state of the user U that varies accumulatively relating to a predetermined event, or a state of the user U that varies with time relating to a predetermined event.

For example, the estimating unit 43 identifies cluster information that indicates a cluster to which the user U belongs from the user database 31. Subsequently, the estimating unit 43 identifies event information that is associated with the identified cluster information from the cluster database 32. The estimating unit 43 then refers to the user log database 34, and estimates experience of the user U in the event that is indicated by the identified event information based on the activity history of the user U. For example, when the event indicated by the identified event information is “child-raising”, the estimating unit 43 estimates an expected data of delivery or a date of implantation of the user U based on the activity history of the user U. The estimating unit 43 generates experience information that is an experience value of the user U in the event “child-raising” based on the expected data of delivery and the date of implantation estimated, and registers the generated experience information in the user database 31, associating with the corresponding cluster information.

The estimating unit 43 can estimate experience of the user U by using an arbitrary estimation technique. For example, the estimating unit 43 causes an arbitrary learning model, such as neural network and support vector machine (SVM), to learn characteristics of relationship between characteristics in the activity history of the user U and characteristics in experience of the user U in a predetermined event. The estimating unit 43 can cause the learning model that has done learning to estimate experience of the user U by inputting the activity history of the user U. Moreover, the estimating unit 43 can determine whether the user U has taken an action set in advance, and can estimate experience of the user U based on a result of the determination. Furthermore, the estimating unit 43 can perform semantic analysis of post information that has posted by the user U, not only actual actions of the user U, and can estimate experience of the user U based on a result of the semantic analysis.

That is, the estimating unit 43 can estimate experience of the user U based on arbitrary information as long as it estimates experience of the user U in an event corresponding to a community (parent cluster). Moreover, the estimating unit 43 can perform calculation of a value of experience information by an arbitrary method as long as the experience information that indicates experience of the user U is generated such that the value of experience information of a user having more experience takes a higher value.

The acquiring unit 44 acquires experience information that indicates experience of the user U in a predetermined event. More specifically, the acquiring unit 44 acquires information that indicates a state of the user U that varies accumulatively relating to a predetermined event, or information that indicates a state of the user U that varies with time relating to a predetermined event. For example, when receiving a request for distribution of post information from the user U, the acquiring unit 44 refers to the user database 31, and identifies cluster information and experience information of the user U that has issued the request.

The selecting unit 45 selects information to provide to the user U based on the experience information. More specifically, the selecting unit 45 selects information to provide to the user U based on a difference between experience that is indicated by the experience information of the user U to be a destination of distribution and experience of another user related to information to be a candidate to be provided. For example, the selecting unit 45 refers to the post information database 33, and selects, from among pieces of post information posted by other users, information to distribute to the user U based on a difference between experience indicated by the experience information of the user U and experience of the other user that has posted the post information. More specifically, when the difference between the experience indicated by the experience information of the user U and the experience or the other user that has posted the post information falls within a predetermined range, the selecting unit 45 handles the post information as post information to provide to the user U. Furthermore, when the difference of experience does not fall within the predetermined range, the selecting unit 45 exclude the post information from subjects to be provided to the user U.

The selecting unit performs selection of post information, giving consideration to the cluster to which the user U belongs. For example, the selecting unit 45 selects information relating to another user that is classified to the same cluster as the user U. Moreover, the selecting unit 45 selects, when the difference between the experience indicated by the experience information of the user U and experience of another user that is related to post information is within a range of an allowable gap according to the cluster to which the user U is classified, the post information as information to provide to the user U.

Furthermore, the selecting unit 45 selects information to provide to the user U based on a difference between the experience of the user U and experience of another user that has posted post information, and a type of the post information. For example, when the other user has less experience than the experience indicated by the experience information of the user U, the selecting unit 45 selects post information relating to a question posted by the other user as information to provide to the user U. Moreover, when the other user has more experience than the experience indicated by the experience information of the user U, the selecting unit 45 selects post information that is posted by the other user and that is relating to a response to a question posted by the user U, as information to provide to the user U. Furthermore, when experience of the other user that has posted post information exceeds a predetermined threshold, the selecting unit 45 can select the post information as information to provide to the user U.

In the following, one example of processing of selecting post information to provide to the user U01 performed by the selecting unit 45 is explained. In the following explanation, the user ID of the user U01 is “user #01”, and the user ID of the user U02 is “user #02”.

First, when receiving a request from the user U01, the selecting unit 45 accepts a set of the cluster information “cluster CL11” and the experience information “level 5” that are associated with the user ID “user #01” of the user U01 from the acquiring unit 44. In this case, the selecting unit 45 extracts the user ID “user #01” and the user ID “user #02” that are associated with the cluster information “cluster CL11” from the user database 31.

In the example shown in FIG. 5, the experience information “level 5” is registered, associated with the set of the user ID “user #01” and the cluster information “cluster CL11”, and the experience information “level 6” is registered, associated with the set of the user ID “user #02” and the cluster information “cluster CL11”. In this case, the selecting unit 45 determines whether the difference between the experience information “level 5” of the user U01 and the experience information “level 6” of the user U02 is within a range of the allowable gap “3” that is associated with the cluster information “cluster CL11”. When the difference between the experience information “level 5” of the user U01 and the experience information “level 6” of the user U02 is within a range of the allowable gap “3” that is associated with the cluster information “cluster CL11”, the selecting unit 45 adds post information of the user 02 to subject of provision.

Subsequently, the selecting unit 45 determines whether the experience of the user U02 is richer than the experience of the user U01. Comparing the experience information “level 5” of the user U01 and the experience information “level 6” of the user U02, it is found that the experience indicated by the experience information of the user U02 is richer. In this case, the selecting unit 45 extracts post information relating to a response out of pieces of post information that have been posted by the user U02 from the post information database 33. For example, the selecting unit 45 extracts post information that is a response to a question posted by the user U01.

For example, when the experience of the user U02 is poorer than the experience of the user U01, the selecting unit 45 is to extract post information relating to a question out of pieces of post information posted by the user U02 from the post information database 33. Moreover, when the difference between the experience information of the user U01 and the experience information of the user U02 exceeds the allowable gap “3” associated with the cluster information “cluster CL11”, the selecting unit 45 excludes the post information of the user U02 from subjects of provision. The selecting unit 45 selects information to provide to the user U01 by performing the above processing for each of the clusters to which the user U01 is classified.

The selecting unit 45 can select information to provide to a user that has a relationship with the user U, such as the partner of the user U, based on the experience information of the user U. For example, when the user U is registered as the partner of a user that issues a request in the user database 31, the selecting unit 45 identifies experience information of the user U that is the partner of the user that has issued the request. The selecting unit 45 can select information to provide to the user that has issued the request based on the experience information of the user U.

Furthermore, when performing search, not for post information, but for a web content or of an object of transaction, the selecting unit 45 can select information to provide to the user U from among web contents that correspond to search queries input by the user U, and can select information of an object of transaction to propose to the user U from among objects of transaction that correspond to the search queries input by the user U, based on the experience information of the user U.

Moreover, when the information providing apparatus 10 performs processing according to priorities assigned to post information, the selecting unit 45 sets priorities for providing information to be a candidate to be provided to a user based on a difference between experience that is indicated by the experience information of the user U and experience information of another user related to information to be a candidate to be provided. The selecting unit 45 can perform both selection of post information to be a subject of distribution, and priority setting at the same time. For example, the selecting unit 45 assigns priorities to post information according to an experience gap, and can select post information having a priority higher than a predetermined threshold as a subject of distribution.

The providing unit 46 provides post information selected by the selecting unit 45 to the user U. For example, the providing unit 46 creates a content in which pieces of information that are selected by the selecting unit 45 are rearranged based on a date of post, relationship with the user U, relationship with a question and a response, and the like, and distributes the created content to the terminal device 100 of the user U. The providing unit 46 can distribute the post information to the user U so as to be displayed in a display mode based on the set priorities. For example, the providing unit 46 can distribute the post information selected by the selecting unit 45 in descending order of priority, or can create a content in which pieces of information are arranged in descending order of priority, and distribute it. Furthermore, the providing unit 46 can distribute post information in such a manner that post information having a priority lower than a predetermined threshold is not viewed in a normal display mode.

When post information is post information relating to a response to a question, the providing unit 46 arranges buttons to accept an evaluation to the post information in the post information to transmit it. For example, the providing unit 46 distributes a button to make a favorable evaluation to a response and a button to make a negative evaluation to the response together with the post information.

The accepting unit 46 accepts, when the user U selects the button to accept an evaluation of a response, the evaluation of post information relating to the response. The updating unit 48 then updates the allowable gap based on the evaluation accepted by the accepting unit 47. As a result, when the difference between experience that is indicated by the experience information of the user U and experience of another user related to the post information falls within a range of a predetermined allowable gap based on the evaluation, the selecting unit 45 selects the post information as information to provide to the user U.

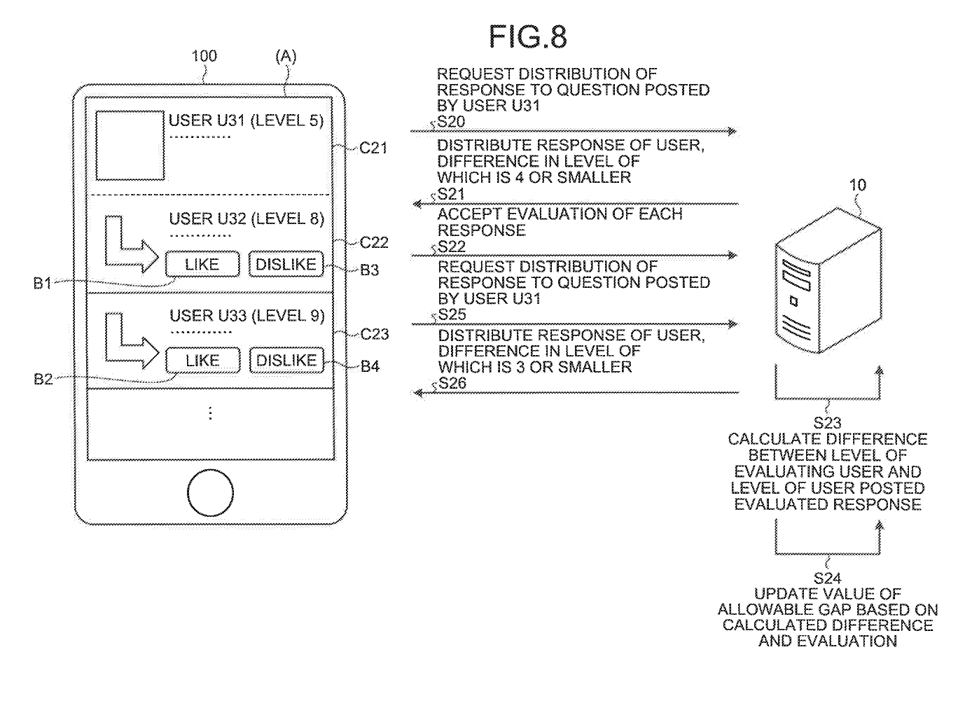

In the following, one example of processing of updating the allowable gap by the providing unit 46, the accepting unit 47, and the updating unit 48 is explained, using FIG. 8. FIG. 8 is a diagram for explaining one example of the processing of updating the allowable gap performed by the information providing apparatus according to the embodiment. In the example shown in FIG. 8, processing of distributing post information to the terminal device 100 used by the user U31 is illustrated. For example, the terminal device 100 requests distribution of a response to a question that is posted by the user U31 (step S20).

In this case, the information providing apparatus 10 distributes a response that is posted by a user, the difference in level from that of the user U31 is 4 or smaller out of users that belong to the same category as the user U31, to the terminal device 100 (step S21). For example, when the level of the user U31 is “5”, the information providing apparatus 10 distributes post information C22 relating to a response of the user U 32, the level of which is “8” and post information C33 relating to a response of the user U23, the level of which is “9”.

In this case, the terminal device 100 displays the post information C21 to the post information C23 aligned as shown in (A) in FIG. 8. Moreover, the terminal device 100 arranges buttons B1, B2 in which characters such as “like” are arranged to accept a favorable evaluation, and buttons B1, B2 in which characters such as “dislike” are arranged to accept a negative evaluation in the post information C22 and the post information C23.

The information providing apparatus 10 then accepts an evaluation of each response when the user U selects the buttons B1 to B4 (step S22). For example, the information providing apparatus 10 accepts an indication that a favorable evaluation is made for the post information C22 when the user U selects the button B1, and accepts an indication that a favorable evaluation is made for the post information C23 when the user U selects the button B2.

Furthermore, the information providing apparatus 10 calculates a difference between the level (that is, experience) of the user U31 that has made the evaluation and each of the levels of the users U32 and U33 that have posted the post information relating to the evaluated responses (step S23). The information providing apparatus 10 updates the value of the allowable gap based on the calculated differences and the evaluations (step S24). For example, when the user U31 selects the button B1, the information providing apparatus 10 records the difference “3” between the level “5” of the user U31 and the level “8” of the user U32, associating with a fact that a favorable evaluation is made. Moreover, when the user U31 selects the button B2, the information providing apparatus 10 records the difference “4” between the level “5” of the user U31 and the level “9” of the user U32, associating with a fact that a negative evaluation is made.

Furthermore, the information providing apparatus 10 performs the same processing for other users that are classified into the same category as the users U31 to U33, and collects sets of a difference in level and an evaluation. The information providing apparatus 10 then learns relationships between the difference in level in the category to which the users U31 to U33 are classified and the evaluations based on the collected information. For example, the information providing apparatus 10 statistically estimates a degree of difference in level when a favorable evaluation or a negative evaluation is made. The information providing apparatus 10 updates the value of the allowable gap of the category to which the users U31 to U33 are classified such that the number of pieces of post information that obtain a favorable evaluation is maximized, and that the number of pieces of post information that obtain a negative evaluation is minimized.

The information providing apparatus 10 can perform any processing other than the processing described above, as long as the value of the allowable gap is updated based on an evaluation of a response. For example, the information providing apparatus 10 can update the value of the allowable gap per one or more categories, or can update the value of the allowable gap per community. Furthermore, the information providing apparatus 10 can update the value of the allowable gap based on evaluations from other users to which the post information C21 to the post information C23 of the users U31 to U33, not only the user U31 that has posted post information relating to a question, are distributed (that is, users that belong to the same cluster as the users U31 to U33, and have experience equivalent to that of the users U31 to U33).

Suppose that the value of the allowable gap is updated to “3” by the processing at step S24. After this processing, the terminal device 100 requests distribution of a response to a question posted by the user U31 (step S25). In this case, the information providing apparatus 10 distributes a response that is posted by a user, the difference in level from the user U31 of which is 3 or smaller to the terminal device 100 (step S26). For example, the information providing apparatus 10 distributes the post information C21 and the post information C22 relating to a response of the user U32, the level of which is “8”. As a result, the information providing apparatus 10 excludes post information that has obtained low evaluations in the community, that is, post information that is posted by other users having a large experience gap from a browsing user from subjects of distribution, thereby enabling harmonious exchanges in the community.

### 4. One Example of Flow of Processing Performed by Information Providing Apparatus

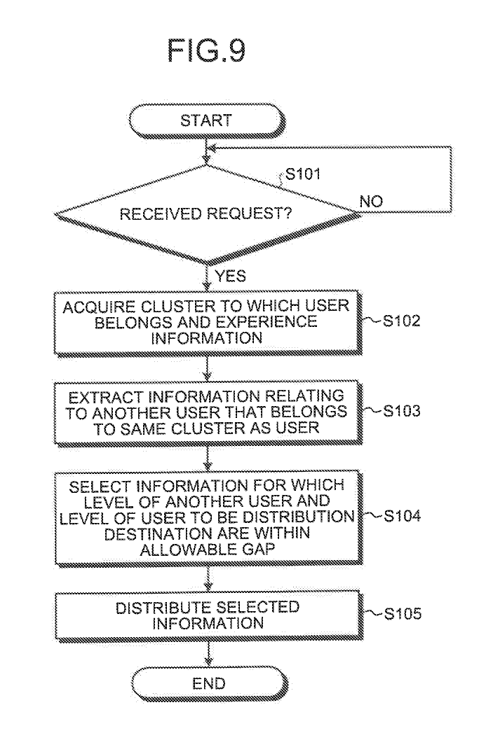

Subsequently, a flow of processing that is performed by the information providing apparatus 10 is explained, using FIG. 9. FIG. 9 is a flowchart showing one example of a flow of the processing that is performed by the information providing apparatus according to the embodiment.

For example, the information providing apparatus 10 determines whether a request from the user U is received (step S101). When a request from the user U is not received (step S101: NO), the information providing apparatus 10 waits until reception. Moreover, when a request is received from the user U (step S101: YES), the information providing apparatus 10 acquires a cluster to which the user U belongs and experience information of the user U (step S102).

Furthermore, the information providing apparatus 10 extracts information relating to another user that belongs to the same cluster as the user U, such as post information posted by the other user that belongs to the same cluster as the user U (step S103). The information providing apparatus 10 then selects information for which the level of the other user falls within the allowable gap from the level of the user U to be a distribution destination (step S104). Subsequently, the information providing apparatus 10 distributes the selected information (step S105), and ends the processing.

### 5. Modification

In the above, one example of providing processing performed by the information providing apparatus 10 is explained. However, embodiments are not limited thereto. In the following, variations of providing processing performed by the information providing apparatus 10 are explained.

### 5-1. Sense of Values

In the above example, the information providing apparatus 10 classifies the user U into a cluster according to a sense of values about child-raising. A sense of values of the cluster is not limited to the sense of values described above. That is, the information providing apparatus 10 can classify users into clusters of arbitrary granularity as long as the users U can be classified in such a manner that estimation is enabled that senses of values are different. For example, the information providing apparatus 10 can classify the users U into a cluster of a user that has purchased a predetermined product relating to a community and a cluster of a user not purchasing it. Moreover, the information providing apparatus 10 can change the granularity of clusters per community. For example, the information providing apparatus 10 can apply large granularity for a community relating to a hobby, such as motorcycle and fishing.

Furthermore, the information providing apparatus 10 can change a cluster to which the user U is classified when the activity history of the user U has changed. That is, the information providing apparatus 10 can update a cluster to which the user U belongs each time by repeatedly performing the processing of classifying the users U at predetermine time intervals.

### 5-2. Embodiments

In the above example, the information providing apparatus 10 performs selection and distribution of post information when a request for post information or the like is received from the user U. However, embodiments are not limited thereto. For example, the information providing apparatus 10 can select arbitrary information based on experience of the user U to be a subject of distribution, and can distribute the selected information by push notification or recommendation. For example, the information providing apparatus 10 estimates, for an event relating to an advertisement to be a subject of distribution, experience of the user U to be a destination of distribution and experience of another user that has selected the advertisement. Moreover, when the experience of the user U and the experience of the other user fall within a predetermined allowable gap, the information providing apparatus 10 can distribute the advertisement to the user U. Furthermore, when the experience of the other user is richer than the experience of the user U, the information providing apparatus 10 can distribute the advertisement.

The information providing apparatus 10 can recommend supplement and food, and maternity clothes suitable for a stage of pregnancy by the selection processing described above, for example, when the user U belongs to a community relating to child-raising. Furthermore, the information providing apparatus 10 can recommend strollers and children's clothes.

That is, the processing described above is only one example, and as long as selecting information to distribute to the user U based on experience of the user U to be a distribution destination of information, the information providing apparatus 10 can distribute any type of information for any subject of distribution.

### 5-3. Experience

Moreover, the information providing apparatus 10 can handle a state of the user U in an arbitrary event as experience. For example, the information providing apparatus 10 can estimate the progress of a state of the user U in an event for which chronological schedule is determined to some extent also in a period other than that from pregnancy to child-raising, and uses information that indicates the estimated progress as the experience. Furthermore, the information providing apparatus 10 can use the progress of an accumulative and gradual state in which after a state of one stage is experienced, a state of a following stage is experienced, such as learning, as the experience.

### 5-4. Configuration of Apparatus

The information providing apparatus 10 can be connected to any number of the terminal devices 100 in a communication-enabled manner. Moreover, the information providing apparatus 10 can be implemented by a frontend server that performs communication of information with the terminal device 100, and a backend server that performs the processing of selecting a place to visit. In this case, the providing unit 46 and the accepting unit 47 shown in FIG. 2 are arranged in the frontend server, and the respective units 41 to 45, 48 are arranged in the backend server. Furthermore, the respective databases 31 to 34 recorded in the storage unit 30 can be held by an external storage server.

### 5-5. Others

Out of the respective processing explained in the above embodiment, all or a part of the processing explained as performed automatically can be performed manually. To the contrary, all or a part of the processing explained as performed manually can be performed automatically by a publicly-known method. In addition, the processing procedure, specific names, information including various kinds of data and parameters that are indicated in the above document and the drawings can be changed arbitrarily unless otherwise specified. For example, the respective kinds of information illustrated in the respective drawings are not limited to the illustrated information.

Furthermore, the respective components of the respective devices illustrated are of functional concept, and it is not necessarily required to be configured physically as illustrated. That is, specific forms of distribution and integration of the respective devices are not limited to the ones illustrated, and all or a part thereof can be configured by distributing or integrating functionally or physically in arbitrary units according to various kinds of loads, usage patterns, and the like.

Moreover, the embodiments described above can be combined appropriately within a range not causing contradictions in the processing.

### 5-6. Program

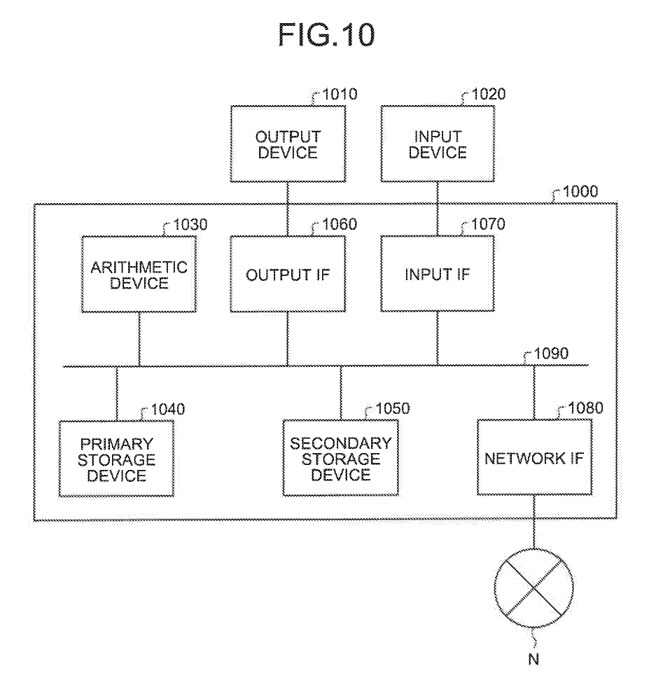

Furthermore, the information providing apparatus 10 according to the embodiment described above can be implemented by, for example, a computer 1000 having a configuration as shown in FIG. 10. FIG. 10 shows one example of a hardware configuration. The computer 1000 are connected to an output device 1010 and an input device 1020, and has a form in which an arithmetic device 1030, a primary storage device 1040, a secondary storage device 1050, an output interface (IF) 1060, an input IF 1070, and a network IF 1080 are connected by a bus 1090.

The arithmetic device 1030 operates based on a program stored in the primary storage device 1040 or a program read from the input device 1020, and performs various kinds of processing. The primary storage device 1040 is a memory device, such as a RAM, that temporarily stores data that is used for various kinds of arithmetic processing by the arithmetic device 1030. Moreover, the secondary storage device 1050 is a storage device that stores data used for various kinds of arithmetic processing by the arithmetic device 1030 and various kinds of databases, and is implemented by a read-only memory (ROM), a hard disk drive (HDD), a flash memory, or the like.

The output IF 1060 is an interface to transmit information that is a subject of output to the output device 1010 that outputs various kinds of information, such as a monitor and a printer, and is implemented, for example, by a connector of a standard such as a universal serial bus (USB), a digital visual interface (DVI), and high definition multimedia interface (HDMI (registered trademark)). Furthermore, the input IF 1070 is an interface to receive information from various kinds of the input device 1020, such as a mouse, a keyboard, and a scanner, and is implemented, for example, by a USB, or the like.

The input device 1020 can be a device that reads information from an optical recording medium, such as a compact disc (CD), a digital versatile disc (DVD), and a phase change rewritable disk (PD), a magneto-optical recording medium, such as a magneto-optical disk (MO), a tape medium, a magnetic recording medium, a semiconductor memory, or the like. Alternatively, the input device 1020 can be an external recording medium such as a USB memory.

The network IF 1080 receives data from other devices through the network N, transfers it to the arithmetic device 1030, and transmits data that is generated by the arithmetic device 1030 to another device through the network N.

The arithmetic device 1030 controls the output device 1010 and the input device 1020 through the output IF 1060 and the input IF 1070. For example, the arithmetic device 1030 loads a program from the input device 1020 or the secondary storage device 1050 onto the primary storage device 1040, and executes the loaded program.

For example, when the computer 1000 functions as the information providing apparatus 10, the arithmetic device 1030 of the computer 1000 implements the function of the control unit 40 by executing a program loaded onto the primary storage device 1040.

### 6. Effects

As described above, the information providing apparatus 10 acquires the experience information that indicates experience of the user relating to a predetermined event. The information providing apparatus 10 then selects information to provide to the user U based on the experience information. Therefore, the information providing apparatus 10 can prevent criticism and slander due to an experience gap, and as a result, harmonious exchanges among users can be achieved.

Furthermore, the information providing apparatus 10 acquires information that indicates a state of the user U that varies accumulatively relating to a predetermined event as the experience information. Moreover, the information providing apparatus 10 acquires information that indicates a state of the user U that varies with time relating to a predetermined event. Therefore, the information providing apparatus 10 can select information to provide to the user U based on information that indicates experience of the user U appropriately.

Moreover, the information providing apparatus 10 sets priorities for providing information to be a candidate to be provided to the user U based on a difference between experience that is indicated by the experience information of the user U and experience of another user related to the information to be a candidate of provision. Therefore, the information providing apparatus 10 can provide a response or the like that is posted by another user, the difference in experience from the user U falls within a predetermined range, and that has more experience than the user U, giving a higher priority thereto.

Furthermore, the information providing apparatus 10 distributes, to the user U, information to be a candidate of provision in a display mode based on set priorities. Therefore, for example, the information providing apparatus 10 can provide a response that is posted by another user, the difference in experience from the user U of which falls within a predetermined range, and that has more experience than the user U giving a higher priority thereto, and can performs filtering process such that post information of another user, the difference in experience from the user U of which is out of a predetermined range, or another user that has less experience than the user U becomes difficult to be viewed. Therefore, criticism and slander due to an experience gap are prevented, and harmonious exchanges among users can be achieved.

Moreover, the information providing apparatus 10 selects information to provide to the user U based on the difference between experience that is indicated by the experience information of the user U and experience of another user related to information to be a candidate of provision. For example, the information providing apparatus 10 selects information to provide to the user U based on the difference between experience that is indicated by the experience information of the user U and experience that is indicated by the experience information of the user U that has posted the information to be a candidate of provision. Therefore, criticism and slander due to an experience gap can be prevented.

Furthermore, when the difference between experience indicated by the experience information of the user U and experience of another user related to information to be a candidate of provision falls within a predetermined range, the information providing apparatus 10 selects the information as information to provide to the user U. Moreover, when the difference in experience is not within the predetermined range, the information providing apparatus 10 excludes the information from a subject to be provided to the user U. Furthermore, when experience of another user is poorer than experience indicated by the experience information of the user U, the information providing apparatus 10 selects information relating to a question posted by the other user as information to provide to the user U. Moreover, when experience of another user is richer than experience indicated by the experience information of the user U, the information providing apparatus 10 selects information that is posted by the other user, and that relates to a response corresponding to a question that is posted by the user U as information to provide to the user U. Therefore, the information providing apparatus 10 can prevent criticism and slander due to an experience gap, and enables harmonious exchanges among users.

Furthermore, the information providing apparatus 10 accepts an evaluation of information relating to a response. The information providing apparatus 10 selects information, when the difference between experience indicated by the experience information of the user U and experience of another user relating to the information falls within a predetermined threshold based on the evaluation accepted by the accepting unit, the information as information to provide to the user U. Therefore, the information providing apparatus 10 can select information to provide to the user U based on an appropriate allowable gap.

Moreover, when experience of another user relating to information exceeds a predetermined threshold, the information providing apparatus 10 selects the information relating to the other user, as information to provide to the user U. Therefore, the information providing apparatus 10 can provide a post of, for example, a specialist or the like to the user U.

Furthermore, the information providing apparatus 10 selects information to provide to the user U based on a difference in experience and a type of information. Therefore, the information to provide to the user U can provide a response by a user that has more experience than the user U, and can provide a question by a user that has less experience than the user U. Therefore, harmonious exchanges among users can be achieved.

Moreover, the information providing apparatus 10 classifies the user U to either one of clusters according to a sense of values of the user U about a predetermined event based on an attribute of the user U. The information providing apparatus 10 selects information relating to the other user U classified into the same cluster as the user U as information to provide to the user U. Therefore, the information to provide to the user U can prevent criticism and slander due to an experience gap, and as a result, harmonious exchanges among users can be achieved.

Furthermore, when the difference between experience indicated by the experience information of the user U and experience of another user related to information falls within a predetermined range according to a cluster to which the user U is classified, the information providing apparatus 10 selects the information as information to provide to the user U. Therefore, the information providing apparatus 10 can set an allowable gap per cluster to achieve harmonious exchanges among users.

Moreover, the information providing apparatus 10 estimates experience of the user U in a predetermined event based on an activity history of the user U. Therefore, the information providing apparatus 10 can achieve selection of information based on experience of the user U without accepting registration of experience from the user U.

Furthermore, the information providing apparatus 10 selects, based on experience of the user U, information to provide to the other user U related to the user U. Therefore, for example, the information to provide to the user U can provide information according to the experience of the user U that is pregnant, to another user that is the partner of the user U that is pregnant.

Moreover, the information providing apparatus 10 selects information to provide to the user U from among pieces of information posted by other users based on the experience information of the user U. Moreover, the information providing apparatus 10 selects information to provide to the user U from among pieces of information corresponding to search queries that are input by the user U based on the experience information of the user U. Furthermore, the information providing apparatus 10 selects information of an object of transaction to be proposed to the user U based on the experience information. Therefore, the information providing apparatus 10 can provide a result of various searches or information about an object of transaction according to the experience of the user U.

As above, embodiments of the present application have been explained in detail based on the drawings, but these are only examples, and the present invention can be implemented by, in addition to the described embodiments, other forms obtained by applying various modifications and improvements based on knowledge of a person skilled in the art.

Furthermore, “unit” described above can be replaced with “means” or “circuit”. For example, the selecting unit can be replaced with a selecting means or a selecting circuit.

According to one aspect of the embodiment, harmonious exchanges among users is enabled.

Although the embodiments has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A selecting device comprising:
an acquiring unit that acquires experience information that indicates experience of a user in a predetermined event; and
a selecting unit that selects information to provide to the user based on the experience information.

2. The selecting device according to claim 1, wherein
the acquiring unit acquires information that indicates a state of the user that varies accumulatively relating to the predetermined event as the experience information.

3. The selecting device according to claim 1, wherein
the acquiring unit acquires information that indicates a state of the user that varies with time relating to the predetermined event as the experience information.

4. The selecting device according to claim 1, wherein
the selecting unit sets priorities for providing information to be a provision candidate to the user based on a difference between experience that is indicated by the experience information of the user and experience of another user related to the information to be a provision candidate.

5. The selecting unit according to claim 4, further comprising
a providing unit that provides information to be the provision candidate to the user so as to be displayed in a display mode based on the priorities set by the selecting unit.

6. The selecting unit according to claim 1, wherein
the selecting unit selects information to provide to the user based on a difference between experience that is indicated by the experience information of the user and experience of another user related to information to be a provision candidate.

7. The selecting device according to claim 6, wherein
the selecting unit selects information to provide to the user based on a difference between experience that is indicated by the experience information of the user and experience that is indicated by the experience information of a user that has posted information to be a provision candidate.

8. The selecting device according to claim 6, wherein
the selecting unit selects the information as information to provide to the user when the difference between the experience that is indicated by the experience information of the user and the experience of the other user related to the information to be a provision candidate is within a predetermined range.

9. The selecting device according to claim 6, wherein
the selecting unit excludes the information to be a provision candidate from subjects to be provided to the user when the difference of the experiences is not within the predetermined range.

10. The selecting device according to claim 6, wherein
the selecting unit selects, when the experience of the other user is poorer than the experience that is indicated by the experience information of the user, information relating to a question that is posted by the other user as information to provide to the user.

11. The selecting device according to claim 6, wherein
the selecting unit selects, when the experience of the other user is richer than the experience that is indicated by the experience information of the user, information that is posted by the other user relating to a response to a question posted by the user as information to provide to the user.

12. The selecting device according to claim 11, further comprising
an accepting unit that accepts an evaluation of the information relating to the response, wherein
the selecting unit selects, when the difference between the experience that is indicated by the experience information of the user and the experience of the other user related to information is within a predetermined range based on the evaluation accepted by the accepting unit, the information as information to provide to the user.

13. The selecting device according to claim 1, wherein
the selecting unit selects, when experience of another user that is related to the information exceeds a predetermined threshold, information relating to the other user as information to provide to the user.

14. The selecting device according to claim 1, wherein
the selecting unit provides information to the user based on the difference in experience and a type of the information.

15. The selecting device according to claim 1, further comprising
a classifying unit that classifies the user into either one of clusters according to a sense of values of the user about the predetermined event, based on an attribute of the user, wherein
the selecting unit selects information related to a user that is classified into an identical cluster to the user, as information to provide to the user.

16. The selecting device according to claim 15, wherein
the selecting unit selects, when the difference between the experience that is indicated by the experience information of the user and experience of another user related to information to be a provision candidate is within a predetermined range according to the cluster to which the user is classified, the information as information to provide to the user.

17. The selecting device according to claim 1, further comprising
an estimating unit that estimates experience of the user in the predetermined event based on an activity history of the user.

18. The selecting device according to claim 1, wherein
the selecting unit selects information to provide to a user having a relationship with the user based on the experience information of the user.

19. The selecting device according to claim 1, wherein
the selecting unit selects information to provide to the user from among pieces of information that are posted by other users, based on the experience information of the user.

20. The selecting device according to claim 1, wherein
the selecting unit selects information to provide to the user from among pieces of information that correspond to search queries input by the user, based on the experience information of the user.

21. The selecting device according to claim 1, wherein
the selecting unit selects information of an object of transaction to propose to the user, based on the experience information.

22. A selecting method comprising:
acquiring experience information that indicates experience of a user in a predetermined event; and
selecting information to provide to the user based on the experience information.

23. A non-transitory computer-readable recording medium having stored a selecting program that causes a computer to execute a process comprising:
acquiring experience information that indicates experience of a user in a predetermined event; and
selecting information to provide to the user based on the experience information.
